(19) United States
(12) Patent Application Publication
(10) Pub. No.: US 2009/0169045 A1
(43) Pub. Date: Jul. 2, 2009

(54) Display Device with Hidden Speaker Assemblies

(76) Inventors: Chih-Hung Liu, Tainan (TW); Wei-Hsin Hsieh, Tainan (TW); Yea-Jye Hou, Tainan (TW)

Correspondence Address: Nixon Peabody LLP, 200 Page Mill Road, Suite 200, Palo Alto, CA, 94306, US

(21) Appl. No.: 11/964,669

(22) Filed: Dec. 26, 2007

(51) Int. Cl. H04R 1/02

(52) U.S. Cl. 381/388

(57) ABSTRACT

A display device includes a display panel, a frame, and a speaker unit. The frame encloses a periphery of the display panel. The speaker unit includes a speaker housing and a speaker assembly. The speaker housing includes first and second housing parts. The first housing part is connected to the frame, has a front opening, and is formed with a hole. The second housing part is mounted on a rear side of the display panel, defines a chamber, and has an open end. The open end of the second housing part is connected to the first housing part such that the chamber in the second housing part is in spatial communication with the front opening in the first housing part through the hole. The speaker assembly is disposed in the chamber in the second housing part and is coupled electrically to the display panel.

### BACKGROUND OF THE INVENTION

1. Field of the Invention

This invention relates to a display device, more particularly to a display device with hidden speaker assemblies.

2. Description of the Related Art

FIG. 1 illustrates a conventional display device 1, such as a liquid crystal display (LCD) television set, which includes a display panel 11, a frame 12, a speaker unit 13, and a stand 14. The display panel 11 has opposite front and rear sides 111, 112, and a periphery 113 disposed between the front and rear sides 111, 112 thereof. The frame 12 encloses the periphery 113 of the display panel 11, and has top and bottom frame parts 121, 122, and left and right frame parts 123, 124. The speaker unit 13 includes a speaker housing 131 and a pair of speakers 132. The speaker housing 131 is connected to the bottom frame part 122 of the frame 12, defines a chamber 130, and is formed with a plurality of holes 133. Each of the speakers 132 is disposed in the chamber 130 and is coupled to the display panel 11. The stand 14 is connected to the display panel 11 and supports the display panel 11 on a flat surface (not shown).

The aforementioned conventional display device 1 is disadvantageous in that, since the speakers 132 are visible through the holes 133 in the speaker housing 131, the conventional display device 1 is not aesthetically pleasing.

### SUMMARY OF THE INVENTION

Therefore, the object of the present invention is to provide a display device that is aesthetically pleasing.

According to the present invention, a display device comprises a display panel, a frame, and a speaker unit. The display panel has opposite front and rear sides, and a periphery that is disposed between the front and rear sides thereof. The frame encloses the periphery of the display panel. The speaker unit includes a speaker housing and a speaker assembly. The speaker housing includes first and second housing parts. The first housing part is connected to the frame, defines a chamber, has a front opening, and is formed with a hole that is in spatial communication with the front opening through the chamber. The second housing part is mounted on the rear side of the display panel, defines a chamber, and has an open end. The open end of the second housing part is connected to the first housing part such that the chamber in the second housing part is in spatial communication with the chamber in the first housing part through the hole. The speaker assembly is disposed in the chamber in the second housing part and is coupled electrically to the display panel.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional display device;

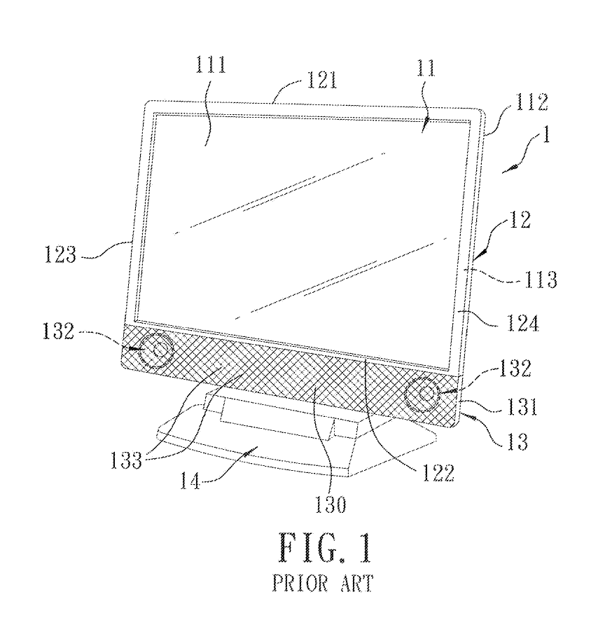

FIG. 2 is a perspective view of the first preferred embodiment of a display device according to the present invention;

FIG. 3 is a fragmentary sectional view of the first preferred embodiment in an assembled state;

FIG. 4 is an exploded perspective view to illustrate a speaker unit of the first preferred embodiment;

FIG. 5 is an exploded perspective view of the second preferred embodiment of a display device according to the present invention; and

FIG. 6 is a fragmentary sectional view of the second preferred embodiment in an assembled state.

### DETAILED DESCRIPTION OF THE PREFERRED EMBODIMENTS

Before the present invention is described in greater detail, it should be noted that like elements are denoted by the same reference numerals throughout the disclosure.

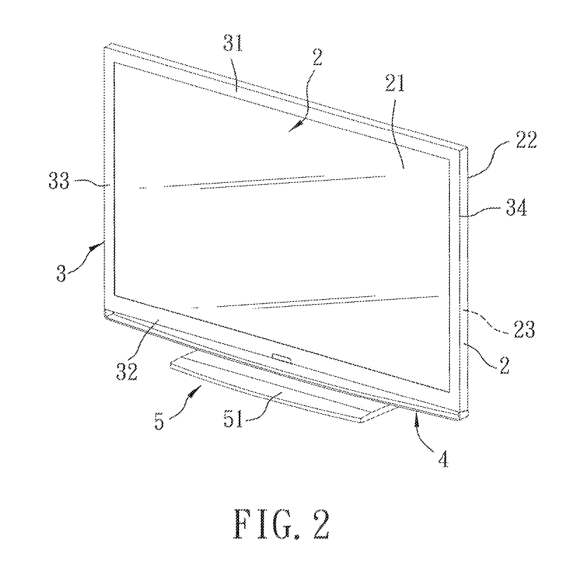

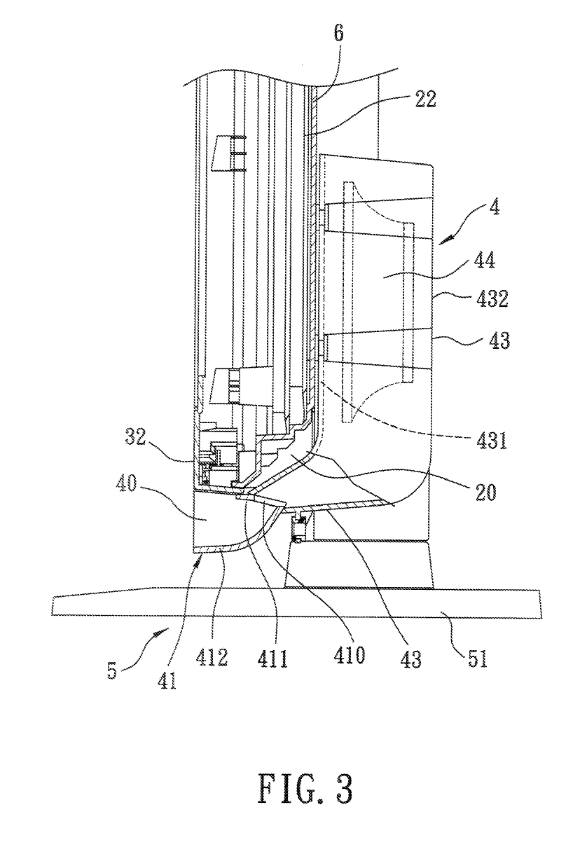

Referring to FIGS. 2 and 3, the first preferred embodiment of a display device according to this invention is shown to include a display panel 2, a frame 3, and a speaker unit 1.

In this embodiment, the display device is a liquid crystal display (LCD) television set.

The display panel 2 is generally rectangular, and has opposite front and rear sides 21, 22, and a periphery 23 that is disposed between the front and rear sides 21, 22 thereof.

The frame 3 encloses the periphery 23 of the display panel 2, and has top and bottom parts 31, 32, and left and right frame parts 33, 34. In this embodiment, the frame 3 is in snap engagement with the periphery 23 of the display panel 2.

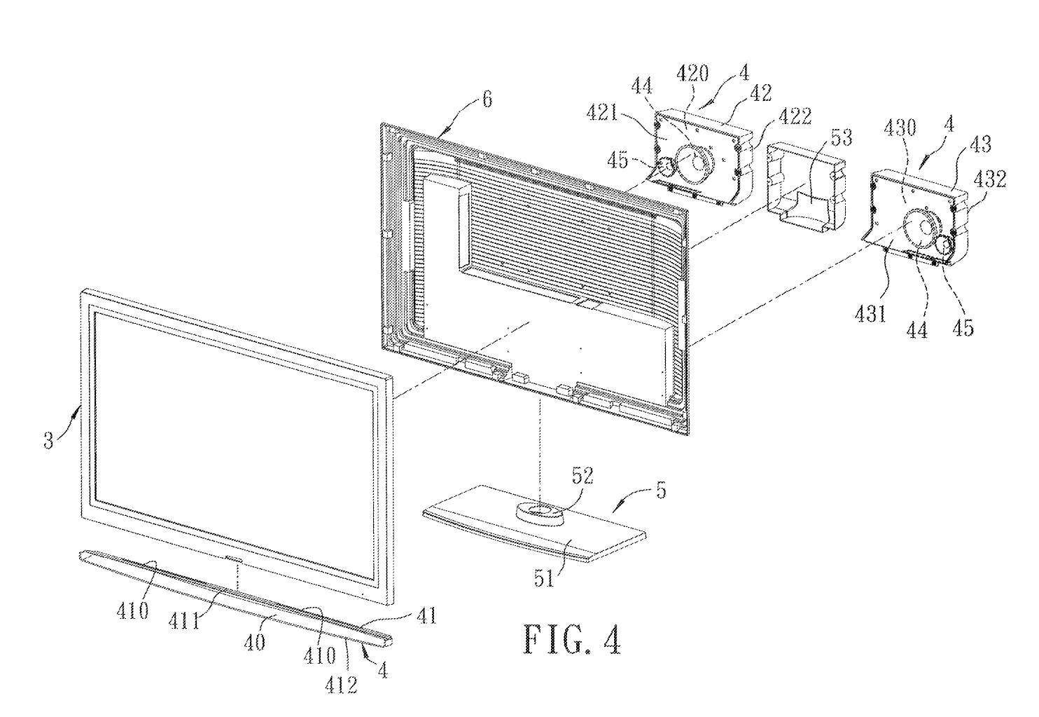

With further reference to FIG. 4, the display device further includes a rear cover 6 that is connected to the frame 3 and that covers the rear side 22 of the display panel 2. As best shown in FIG. 3, the rear cover 6 and the rear side 22 of the display panel 2 cooperatively define an accommodating space 20 therebetween.

The speaker unit 4 includes a speaker housing and a pair of speaker assemblies. The speaker housing is made from a plastic material, and includes first and second housing parts 41, 42, and a third housing part 43. The first housing part 41 defines a chamber, has a front opening 40, and includes first and second walls 411, 412 that cooperatively define the chamber therebetween. The first wall 411 of the first housing part 41 is connected to the bottom frame part 32 of the frame 3, and is formed with first and second sets of holes 410, each of which is in spatial communication with the front opening 40 in the first housing part 41 through the chamber in the first housing part 41. The second wall 412 of the first housing part 41 has an arcuate shape.

The second housing part 42 is disposed externally of the accommodating space 20 adjacent to the left frame part 33 of the frame 3, defines a chamber 420, has an open end, and includes first and second walls 421, 422. The first wall 421 of the second housing part 42 is mounted on the rear cover 6. The open end of the second housing part 42 is connected to the first housing part 41 such that the chamber 420 of the second housing part 42 is in spatial communication with the chamber of the first housing part 41 through the holes 410 in the first set.

The third housing part 43 is disposed externally of the accommodating space 20 adjacent to the right frame part 34 of the frame 3, defines a chamber 430, has an open end, and includes first and second walls 431, 432. The first wall 431 of the third housing part 43 is mounted on the rear cover 6. The open end of the third housing part 43 is connected to the first housing part 41 such that the chamber 430 of the third housing part 43 is in spatial communication with the chamber of the first housing part 41 through the holes 410 in the second set.

In this embodiment, as best shown in FIG. 3, the first and third housing parts 41, 43, as well as the first and second housing parts 41, 42 (not visible in FIG. 3), form a substantially L-shaped cross section.

Each of the speaker assemblies includes a pair of speakers 44, 45, is disposed in the chamber 420, 430 in a respective one of the second and third housing parts 42, 43, is coupled electrically to the display panel 2, and is operable so as to generate sounds.

In operation, the sounds generated by each of the speaker assemblies is directed from the chamber 420, 430 of a respective one of the second and third housing parts 42, 43, pass through the holes 410 in a respective one of the first and second sets, further pass through the chamber in the first housing part 41, and exit out through the front opening 40 in the first housing part 41.

Although each of the speaker assemblies is exemplified using only a pair of speakers 44, 45, it should be apparent to those skilled in the art that the number of speakers of each of the speaker assemblies may be increased or decreased as required.

The display device further includes a stand 5 that supports the display panel 2 on a fiat surface (not shown). In particular, the stand 5 includes a base member 51 disposed on the flat surface, a coupling member 52 mounted securely on the base member 51, and a rotatable member 53 connected rotatably to the coupling member 52. The rear cover 6 is connected securely to the rotatable member 53 to thereby couple rotatably the display panel 2 to the base member 51 of the stand 5.

In an alternative embodiment, the rear cover 6 and the rotatable member 53 are formed integrally.

From the above description, since the speaker assemblies are disposed at the rear side 22 of the display panel 2 and are therefore not visible from the front side 21 of the display panel 2, the display device of this invention is aesthetically pleasing.

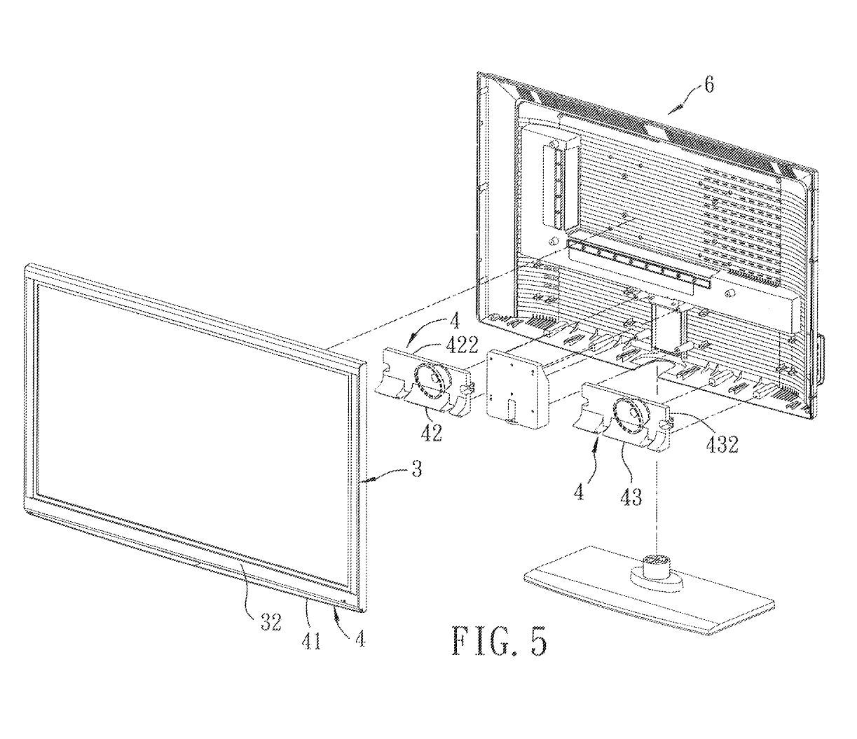

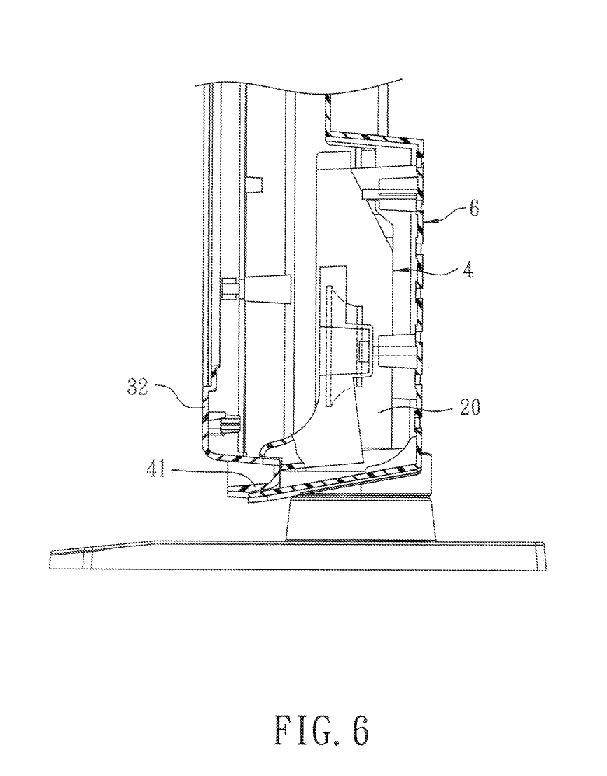

FIGS. 5 and 6 illustrate the second preferred embodiment of a display device according to this invention. When compared with the previous embodiment, the bottom frame part 32 of the frame 3 and the first housing part 41 are formed integrally. The second and third housing parts 42, 43 are disposed in the accommodating space 20. The second walls 422, 432 of the second and third housing parts 42, 43 are mounted on the rear cover 6.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A display device, comprising:
a display panel having opposite front and rear sides, and a periphery that is disposed between said front and rear sides thereof;
a frame enclosing said periphery of said display panel; and
a speaker unit including
a speaker housing that includes first and second housing parts, said first housing part being connected to said frame, defining a chamber, having a front opening, and being formed with a hole that is in spatial communication with said front opening through said chamber, said second housing part being mounted on said rear side of said display panel, defining a chamber, and having an open end, said open end of said second housing part being connected to said first housing part such that said chamber in said second housing part is in spatial communication with said chamber in said first housing part through said hole, and
a speaker assembly that is disposed in said chamber in said second housing part and that is coupled electrically to said display panel.

2. The display device as claimed in claim 1, wherein said first housing part includes first and second walls that cooperatively define said chamber therebetween, said first wall of said first housing part being connected to said frame, said second wall of said first housing part having an arcuate shape, said hole being formed in said first wall of said first housing part.

3. The display device as claimed in claim 1, wherein said first and second housing parts form a substantially L-shaped cross section.

4. The display device as claimed in claim 1, further comprising a rear cover connected to said frame for covering said rear side of said display panel, said rear side of said display panel and said rear cover defining an accommodating space therebetween, said second housing part of said speaker unit being disposed externally of said accommodating space and mounted on said rear cover.

5. The display device as claimed in claim 1, further comprising a rear cover connected to said frame for covering said rear side of said display panel, said rear side of said display panel and said rear cover defining an accommodating space therebetween, said second housing part of said speaker unit being disposed in said accommodating space and mounted on said rear cover.

6. The display device as claimed in claim 1, wherein said first housing part and said frame are formed integrally.

7. The display device as claimed in claim 1, wherein said speaker assembly includes at least a speaker.

8. The display device as claimed in claim 1, further comprising a stand adapted to support said display panel on a flat surface, said display panel being coupled rotatably to said stand.

9. The display device as claimed in claim 8, wherein said stand includes a base member adapted to be disposed on the surface, a coupling member mounted securely on said base member, and a rotatable member connected rotatably to said coupling member, said display panel being coupled securely to said rotatable member.
